(19) United States
(12) Patent Application Publication
(10) Pub. No.: US 2009/0087168 A1
(43) Pub. Date: Apr. 2, 2009

(54) METHOD AND APPARATUS FOR REPRODUCING MEDIA CONTENTS USING NON-VOLATILE STORAGE MEDIUM

(75) Inventors: Chan-ho PARK, Suwon-si (KR); Hyung-gyu LEE, Seoul (KR); Jung-hwan KIM, Seoul (KR); Seong-jun AHN, Seoul (KR); Young-bong KIM, Seoul (KR); Shine KIM, Pohang-si (KR); Young-il SEO, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/198,388

(22) Filed: Aug. 26, 2008

(30) Foreign Application Priority Data
Oct. 2, 2007 (KR) 10-2007-0099250

(51) Int. Cl. H04N 7/26

(52) U.S. Cl. 386/124

(57) ABSTRACT

The invention relates generally to a method for reproducing digital media content, and more particularly but without limitation, to a method and apparatus for reading a boot code and digital media content from a non-volatile storage medium other than a conventional hard disk drive. In embodiments of the invention, power is limitedly supplied to an apparatus required for reproducing digital media content. Additionally, in embodiments of the invention, the digital media content is reproduced using a non-volatile storage medium other than a conventional hard disk drive (HDD); in particular, embodiments of the invention utilize a solid state drive (SSD) such as a non-volatile cache memory inside a hybrid hard drive (HDD) or an on-board cache memory. Embodiments of the invention also provide an apparatus for performing the method.

### CROSS-REFERENCE TO RELATED PATENT APPLICATIONS

This application claims the benefit of Korean Patent Application No. 10-2007-0099250, filed on Oct. 2, 2007, in the Korean Intellectual Property Office, the disclosure of which is incorporated herein in its entirety by reference.

### BACKGROUND OF THE INVENTION

1. Field of the Invention

The invention relates generally to a method for reproducing digital media content, and more particularly but without limitation, to a method and apparatus for reading a boot code and digital media content from a non-volatile storage medium other than a conventional hard disk drive.

2. Description of the Related Art

In the conventional art, portable computers may be used to store and reproduce (play) digital media content. FIG. 1 is a functional block diagram of a general-purpose computer having a hard disk drive (HDD) according to conventional technology. As illustrated therein, the general-purpose computer includes a central processing unit (CPU) 120, a main memory 130, a HDD 140, a display 110, and peripheral devices 150 through 170. The illustrated peripheral devices include a sound card 150, a digital video disc (DVD) player 160, and a keyboard 170.

A notebook computer supporting an instant-on media play function generally has the structure as illustrated in FIG. 1. In this case, an OS specifically designed to provide a media service is stored on the HDD 140. A media content file may also be stored on the HDD 140. Alternatively, the media content may be stored on a DVD that is read by the DVD player 160. When the specialized OS begins to boot up, drivers for peripheral devices 150 through 170 are called. When booting is completed, a player program loads the media content file from the HDD 140 or DVD player 160, and then the player program reproduces (plays) the media content file.

This conventional method has many disadvantages, however. For example, computer OSs are typically large, resulting in significant delay in launching the multimedia services because of the relatively long OS booting time. In addition, HDDs and DVD players place a significant strain on a portable computer's power supply. An improved method and apparatus for providing a low-power, high-speed multimedia service is therefore needed.

### SUMMARY OF THE INVENTION

Embodiments of the invention provide a method capable of satisfying fast booting and low power consumption objectives. In embodiments of the invention, power is limitedly supplied to an apparatus required for reproducing digital media content. Additionally, in embodiments of the invention, the digital media content is reproduced using a non-volatile storage medium other than a conventional hard disk drive (HDD); in particular, embodiments of the invention utilize a solid state drive (SSD) such as a non-volatile cache memory inside a hybrid hard drive (HDD) or an on-board cache memory. Embodiments of the invention also provide an apparatus for performing the method.

In one respect, the invention provides a method of reproducing digital media content. The method includes: providing power to at least one system component, the at least one system component including a solid state non-volatile storage device; reading a boot code from the solid state non-volatile storage device; and reproducing the digital media content using the boot code, the reproducing including reading the digital media content from the solid state storage device.

In another respect, the invention provides a digital media apparatus. The digital media apparatus includes: a power source unit configured to provide power to at least one component of the digital media apparatus; a solid state non-volatile storage device coupled to the power source, the solid state non-volatile storage device configured to store a boot code and digital media content; a reading unit coupled to the power source and the solid state non-volatile storage device, the reading unit configured to read the boot code; and a reproduction unit coupled to the reading unit and the solid state non-volatile storage device, the reproduction unit configured to reproduce the digital media content based on the boot code.

### BRIEF DESCRIPTION OF THE DRAWINGS

The above and other features and advantages of the invention will become more apparent by describing in detail exemplary embodiments thereof with reference to the attached drawings in which:

FIG. 1 is a functional block diagram of a general-purpose computer having a hard disk drive (HDD), according to conventional technology;

FIG. 2 is a flowchart of a method for reproducing digital media content, according to an embodiment of the invention;

FIG. 3 is a flowchart of a method for reproducing digital media content, according to another embodiment of the invention;

FIGS. 4A-4C are illustrations of alternative data structures in a solid state non-volatile storage medium, according to embodiments of the invention;

FIG. 5 is a functional block diagram of an apparatus for reproducing digital media content, according to an embodiment of the invention; and

FIG. 6 is a functional block diagram of an apparatus for reproducing digital media content, according to another embodiment of the invention.

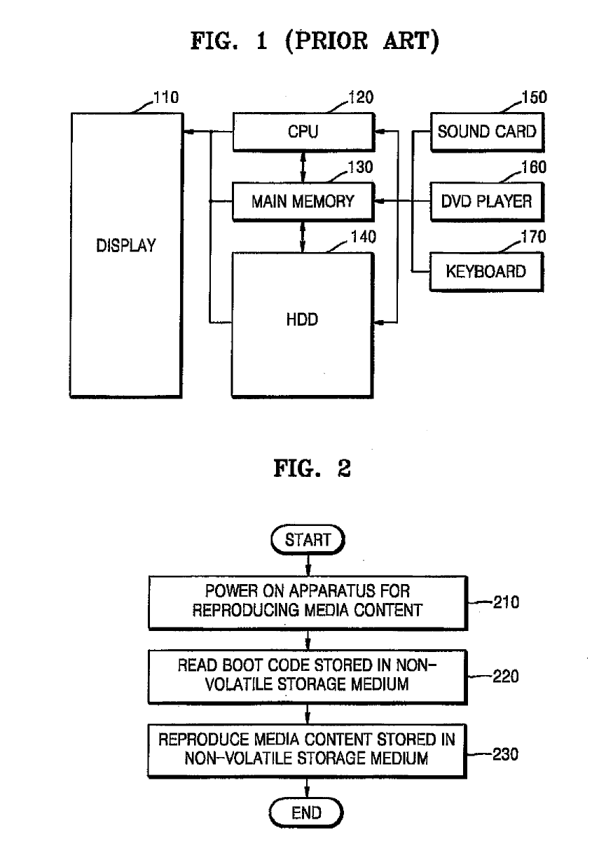

In the drawings, whenever the same element reappears in subsequent drawings, it is denoted by the same reference numeral.

### DETAILED DESCRIPTION OF THE INVENTION

Hereinafter, the invention will be described in detail by explaining preferred embodiments of the invention with reference to the attached drawings.

FIG. 2 is a flowchart of a method for reproducing digital media content, according to an embodiment of the invention.

Referring to FIG. 2, the method of reproducing digital media content includes providing power to an apparatus for reproducing digital media content (operation 210), reading a boot code stored in a non-volatile storage medium in the apparatus to which power is supplied (operation 220), and reproducing the digital media content that is also stored in the non-volatile storage medium based on the read boot code (operation 230).

In operation 210, power is provided to the apparatus for reproducing digital media content. Specifically, power is provided, not to all elements of the system, but rather only to one or more system components that are required to reproduce digital media content. Such selective application of power during a media service application may advantageously extend the life of a battery power source in a portable computer.

In operation 220, boot code is read from a non-volatile storage medium. The boot code may be associated with a specialized operating system (OS) and may include an interface program. The interface program may be or include, for example, a device driver to control data input/output. The non-volatile storage medium used in step 220 could be or include, for example, a non-volatile cache memory disposed inside a hybrid hard disk, an on-board cache memory in the form of a peripheral component interconnect (PCI) card, or other SSD.

In operation 230, digital media content that is also stored in the non-volatile storage medium is reproduced (played). The digital media content may be or include, for example, an audio and/or video stream.

By booting the OS and the included interface program from an SSD, boot-up latency and power consumption are reduced.

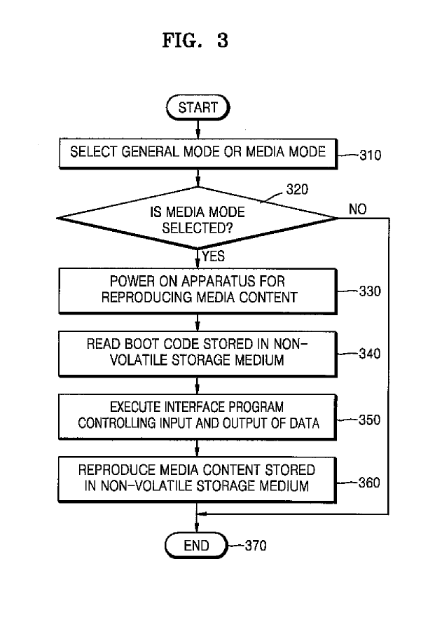

FIG. 3 is a flowchart of a method for reproducing digital media content, according to another embodiment of the invention.

Referring to FIG. 3, the method for reproducing digital media content includes selecting between a general mode (associated with a host OS) or a media mode for reproducing the digital media content (operation 310). When the process determines that the media mode is selected (operation 320), then the process provides power to a component associated with reproducing the digital media content (operation 330), reads boot code stored in a non-volatile storage medium in the apparatus to which power is supplied (operation 340), executes an interface program that controls data input to and output from the apparatus (operation 350), reproduces the digital media content stored in the non-volatile storage medium using the executed interface program (operation 360), and terminates in operation 370.

In operation 310, a use mode is selected. More specifically, the process selects either a general mode or a media mode in operation 310.

The general mode is, for example, a mode for using a notebook computer as an ordinary host personal computer (PC). In the general mode, the host OS can execute a variety of applications, for instance document processing, network communication, and/or a media service application. The general mode may utilize, for example, among other components, a network adaptor card and an integrated device electronics/advanced technology attachment (IDE/ATA) controller.

Meanwhile, the media mode is a mode for providing only a predetermined media service (application). As described below, in this mode, the process optimizes an environment during the booting process. In particular, in the media mode of the current embodiment, the process does not power a spindle motor in a hard disk drive. A hard disk drive can consume 10% to 20% of the power in a system. Power consumption is therefore reduced by not driving a hard disk in the media mode. Instead, in the media mode, the boot code and the digital media content are stored in a SSD. The SSD may be, for example, a non-volatile cache memory disposed in a hybrid hard disk or an on-board cache memory.

In operation 320, it is determined whether or not the media mode is selected. This can be determined according to an input, using hardware or software. When hardware is used, the mode can be determined, for example, according to the position of a media mode switch. When software is used, a prompt or other command interface may be presented to user.

In operation 330, power is provided to the apparatus for reproducing the digital media content. As described above, power is not provided to all elements of the system, but limitedly provided to at least one component that is required for reproducing the digital media content. In order to boot a system using a SSD, in particular a non-volatile cache memory disposed in a hybrid hard disk or an on-board cache memory, it is necessary to correct a basic input/output system (BIOS) beforehand. In the case of a hybrid hard disk, power is not supplied to the spindle motor (used to spin a platter in the hard disk) during the media mode.

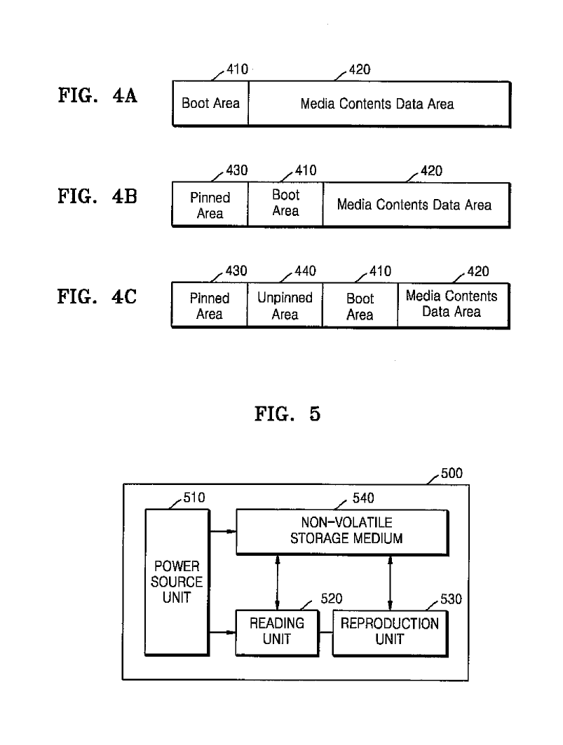

In operation 340, a boot code is read from the SSD. The SSD may be partitioned into at least a boot area (in which a boot code is disposed) and a media content data area (in which digital media content is disposed). Accordingly, the boot code for a specialized OS is read from the boot area. Exemplary data structures for the SSD will be explained later with reference to FIGS. 4A-4C.

The boot code may include an interface program for controlling data input to and output from a media reproducing apparatus. The interface program is executed in operation 350.

In operation 360, the digital media content stored in the SSD is reproduced using the executed interface program.

FIGS. 4A-4C are illustrations of alternative data structures in a solid state non-volatile storage medium, according to embodiments of the invention.

In a hybrid hard disk, a non-volatile cache memory (hereinafter referred to as an “NV cache”) disposed in the hybrid hard disk may include a pinned area and an unpinned area. The pinned area is dedicated to a host OS, thereby allowing faster processing when host booting and application programs are executed. The unpinned area may be used as a write buffer. The pinned area and the unpinned area may be distinguished by logical block address (LBA).

FIGS. 4A-4C illustrate three alternative NV cache configurations.

The first configuration, illustrated in FIG. 4A, uses the entire area of the NV cache for a media service (application). Accordingly, the first configuration includes a boot area 410 and a media content data area 420. The boot area 410 and the media content data area 420 are unpinned.

The second configuration, illustrated in FIG. 4B, includes areas 410 and 420, but adds a pinned area 430 that is used by a host OS. In other words, only the unpinned set areas (410 and 420) are used for a media service in a media mode.

The third configuration, illustrated in FIG. 4C, includes areas 410, 420, and 430, as described above, but further adds an unpinned area 440. The unpinned area 440 may be used, for example, as a ReadyDrive or other general purpose cache memory area.

In the first and second configurations (illustrated in FIGS. 4A and 4B, respectively), the space dedicated for the media service is a relatively large portion of the NV cache. This may be an advantage in that a relatively larger amount of digital media content can be stored in the NV cache. The host OS may record the corresponding area of the NV cache associated with providing a media service.

The third configuration (illustrated in FIG. 4C) has a relatively smaller available space for a media service. But the third configuration has an advantage in that a portion of the NV cache can be used as a ReadyDrive or other general purpose cache memory area.

When the overall NV cache is relatively large, the third configuration may be most advantageous. When the overall NV cache is relatively small, the first or second configurations may be most advantageous so that a smooth media service can be provided.

FIG. 5 is a functional block diagram of an apparatus 500 for reproducing digital media content, according to an embodiment of the invention. Referring to FIG. 5, the apparatus 500 includes a power source unit 510, a reading unit 520, a reproduction unit 530, and a non-volatile storage medium 540.

The power source unit 510 is configured to provide power to components of the apparatus 500 in a media mode. The reading unit 520 is configured to read boot code stored in the non-volatile storage medium 540. The boot code read by the reading unit 520 is associated with an OS that is specially configured to provide a media service. The reproduction unit 530 is configured to reproduce digital media content stored in the non-volatile storage medium 540 based on the boot code read by the reading unit 520. The digital media content (such as an audio and/or video stream) is stored in the non-volatile storage medium 540.

The non-volatile storage medium 540 may be or include, for example, a non-volatile cache memory disposed inside a hybrid hard disk, an on-board cache memory in the form of a PCI card, or other SSD.

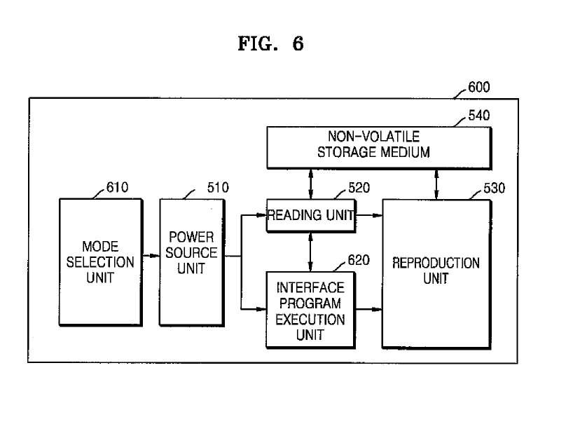

FIG. 6 is a functional block diagram of an apparatus for reproducing digital media content, according to another embodiment of the invention. Referring to FIG. 6, the apparatus 600 also includes the power source unit 510, the reading unit 520, the reproduction unit 530, and the non-volatile storage medium 540, as described above. The apparatus 600 further includes a mode selection unit 610 and an interface program execution unit 620.

The mode selection unit 610 is configured to determine whether a user has selected a general mode or a media mode. The general mode is associated with applications supported by a host OS, and the media mode is associated with reproducing digital media content. The mode selection unit 610 is further configured to output an activation signal to the power source unit 620 such that, during the media mode, the power source unit 510 provides power to components of the apparatus 600 that are necessary for reproducing digital media content.

The interface program execution unit 650 is configured to execute an interface program that is disposed in the boot code read by the reading unit 520. The interface program execution unit 620 is thus configured to control data input to and output from the reproduction unit 530. The interface program may be or include a device driver.

The method for reproducing digital media content using non-volatile storage medium according to the embodiments described above can be embodied in computer programs that are stored in computer-readable recording medium. The programs can then be read and executed, for example, by general-use digital computers. Examples of the computer readable recording medium include magnetic storage media (e.g., ROM, floppy disks, hard disks, etc.), optical recording media (e.g., CD-ROMs, or DVDS), and storage media such as carrier waves (e.g., transmission through the Internet).

While the invention has been particularly shown and described with reference to exemplary embodiments thereof, it will be understood by those of ordinary skill in the art that various changes in form and details may be made without departing from the spirit and scope of the invention as defined by the following claims. The preferred embodiments should be considered in descriptive sense only and not for purposes of limitation.

1. A method of reproducing digital media content comprising:
providing power to at least one system component, the at least one system component including a solid state non-volatile storage device;
reading a boot code from the solid state non-volatile storage device; and
reproducing the digital media content using the boot code, the reproducing including reading the digital media content from the solid state storage device.

2. The method of claim 1, further comprising determining whether a user has selected a general mode or a media mode, the general mode being associated with a host operating system (OS).

3. The method of claim 2, wherein, when it is determined that the user has selected the media mode, providing power includes providing power only to the at least one system component necessary for reproducing the digital medial content.

4. The method of claim 1, wherein providing power includes providing power only to the at least one system component necessary for reproducing the digital media content.

5. The method of claim 2, wherein providing power does not include providing power to a spindle drive motor.

6. The method of claim 1, wherein reading the boot code includes reading an interface program, the interface program configured to control data inputs and outputs.

7. The method of claim 1, wherein the solid state non-volatile storage device includes:
a boot area in which the boot code is disposed; and
a media content data area in which the digital media content is disposed.

8. The method of claim 7, wherein the solid state non-volatile storage device further includes a pinned area, the pinned area being dedicated to a host operating system, each of the boot area, the media area and the pinned area being separate and distinct.

9. The method of claim 8, wherein the solid state non-volatile storage device further includes an unpinned area, the unpinned area being a write buffer, each of the boot area, the media area, the pinned area, and the unpinned area being separate and distinct.

10. The method of claim 1, wherein the solid state non-volatile storage device is a cache memory disposed in a hybrid hard disk.

11. A digital media apparatus comprising:
a power source unit configured to provide power to at least one component of the digital media apparatus;
a solid state non-volatile storage device coupled to the power source, the solid state non-volatile storage device configured to store a boot code and digital media content;
a reading unit coupled to the power source and the solid state non-volatile storage device, the reading unit configured to read the boot code; and
a reproduction unit coupled to the reading unit and the solid state non-volatile storage device, the reproduction unit configured to reproduce the digital media content based on the boot code.

12. The apparatus of claim 11, further comprising a mode selection unit coupled to the power source unit, the mode selection unit configured to receive an input, determine whether the input is associated with a general mode or a media mode, the mode selection unit further configured, if the input signal is associated with the media mode, to output a control signal to the power source unit that causes the power source unit to supply power only to the at least one component necessary for reproducing the digital media content.

13. The apparatus of claim 11, further comprising an interface program execution unit coupled to the power source unit, the reading unit, and the reproduction unit, the interface program execution unit configured to execute an interface program disposed in the boot code.

14. The apparatus of claim 11, wherein the solid state non-volatile storage device includes:
a boot area in which the boot code is disposed; and
a media content data area in which the digital media content is disposed.

15. The apparatus of claim 14, wherein the solid state non-volatile storage device further includes a pinned area, the pinned area being dedicated to a host operating system, each of the boot area, the media area and the pinned area being separate and distinct.

16. The apparatus of claim 15, wherein the solid state non-volatile storage device further includes a unpinned area, the unpinned area being a write buffer, each of the boot area, the media area, the pinned area, and the unpinned area being separate and distinct.

17. The apparatus of claim 11, wherein the solid state non-volatile storage device is a cache memory disposed in a hybrid hard disk.

18. A computer readable recording medium having computer-executable code stored thereon, the computer-executable code configured to execute the method of claim 1.
